(19) United States
(12) Patent Application Publication
(10) Pub. No.: US 2004/0104891 A1
(43) Pub. Date: Jun. 3, 2004

(54) Intertial pointer for electronic displays

(76) Inventors: Frank Sacca, Diamond Bar, CA (US); Edward F. Sacca, Diamond Bar, CA (US)

Correspondence Address: Frank Sacca, 23036 Rio Lobos Road, Diamond Bar, CA, 91765, US

(21) Appl. No.: 10/723,567

(22) Filed: Nov. 25, 2003

Related U.S. Application Data
(60) Provisional application No. 60/429,280, filed on Nov. 25, 2002.

(51) Int. Cl. G09G 5/00

(52) U.S. Cl. 345/156

(57) ABSTRACT

An inertial pointing device and method to determine position coordinates from sensing linear acceleration relative to space (inertia). One or more acceleration sensors detect the acceleration of the pointer in the X, Y, and/or Z directions, respectively. The acceleration of the pointer in each direction is then converted into speed and position at an appropriate integration rate, to determine the coordinates of the pointer on an electronic display. The inertial pointer can be used as a computer mouse, a pointing device for presentation displays, or as a remote control for TV sets.

### BACKGROUND—CROSS-REFERENCE TO RELATED APPLICATIONS

The present application is based on and claims priority to U.S. Provisional Application Serial No. 60/429,280, entitled Inertial Mouse for Computers, filed on Nov. 25, 2002.

### BACKGROUND—INCORPORATION BY REFERENCE

The following patent application is hereby incorporated by reference in its entirety, including drawings, and is hereby made part of this application for all purposes: U.S. Provisional Application Serial No. 60/429,280, entitled Inertial Mouse for Computers, filed on Nov. 25, 2002.

### COPYRIGHT NOTICE

A portion of the disclosure of this patent document contains material that is subject to copyright protection. The copyright owner has no objection to the facsimile reproduction by anyone of the patent disclosure, as it appears in the Patent and Trademark Office patent files or records, but otherwise reserves all copyright rights whatsoever.

### BACKGROUND—FIELD OF INVENTION

The present invention relates to electronic pointing devices, specifically an inertial pointer for electronic displays.

### BACKGROUND—PRIOR ART

Electronic pointing devices have evolved from simple mechanical devices to sophisticated optical scanners. A mechanical computer mouse, for example, is based on a track-ball that rubs against an external mouse pad. Mechanical motion sensors inside the mouse detect the rotation of the track-ball and generate two signals in the X and Y directions, respectively, relative to the motion of the mouse with respect to the mouse pad. These two signals are transmitted to the computer through a cable, generally connected to the computer's serial interface at 9600 baud, and control an electronic pointer to make appropriate selections on the computer screen. The mechanical mouse has traditionally two drawbacks. First, it requires a mouse pad to provide reliable operation. Second, it is prone to malfunction due to accumulation of dust from the track-ball to the mechanical motion sensor components.

An optical mouse is based on the continuous optical scanning of an area below the mouse, which could be the surface of a desk, for example, to determine relative motion between the mouse and the surface in the X and Y directions, respectively. The scanning frequency can be as high as 6,000 frames per second. The mouse coordinates are transmitted to the computer by means of a wire through a serial interface, an infrared (IR) link, or a radio frequency RF link (wireless mouse). The optical mouse does not require a mouse pad, but it still requires a surface against which the mouse must measure relative motion. Furthermore, this device generation is rather expensive compared to the traditional mouse.

Other technologies have evolved for use in pointing devices in general. Pointing devices are very common today as presentation tools on large video screens, video games controllers, and TV remote controls. U.S Pat. No. 5,898,421, entitled “Gyroscopic pointer and method,” for example, teaches the use of “angular velocity” sensors to detect yaw and pitch rotations of a pointing device. The inertial rotation displacements are then converted to X and Y coordinates for use on electronic displays. Although this method eliminates the need for a reference surface, the use of angular physical quantities is generally inconsistent with linear displacements of typical pointing devices. In addition, the conversion from angular displacements to linear displacements can be complex, and the cost of angular sensors can be prohibitive. Lastly, U.S. Pat. No. 6,271,831, entitled “Wireless control and pointer system,” teaches the use of multiple infrared signals at different frequencies to provide X and Y coordinates information based on geometrical reflections of these signals. Because infrared signals are subject to unwanted reflections in the environment where the pointing device is being used, this method results in a formidable challenge for the designer to provide accurate position coordinates.

### OBJECTS AND ADVANTAGES

Accordingly, several objects and advantages of the present invention are:

a) To provide a cost-effective pointing device that does not require a relative reference to detect motion;

b) To provide a pointing device that is simple to implement and reliable; and

c) To provide a pointing device apparatus and method that is suitable for multiple uses, such as a computer mouse, a presentation tool, and a TV remote control.

Further objects and advantages will be apparent from a consideration of the ensuing description and accompanying drawings.

### DESCRIPTION OF DRAWINGS

FIG. 1 shows a block diagram of an inertial pointing device according to the present invention.

FIG. 2 shows a block diagram of a circuit to convert linear acceleration to position coordinates in one axis, according to the present invention.

### SUMMARY OF THE INVENTION

The present invention describes a pointing device that determines position coordinates from sensing linear acceleration relative to space (inertia). One or more acceleration sensors detect the acceleration of the pointer in the X, Y, and/or Z directions, respectively. The acceleration of the pointer in each direction is then converted into speed and position at an appropriate integration rate, to determine the coordinates of the pointer on an electronic display.

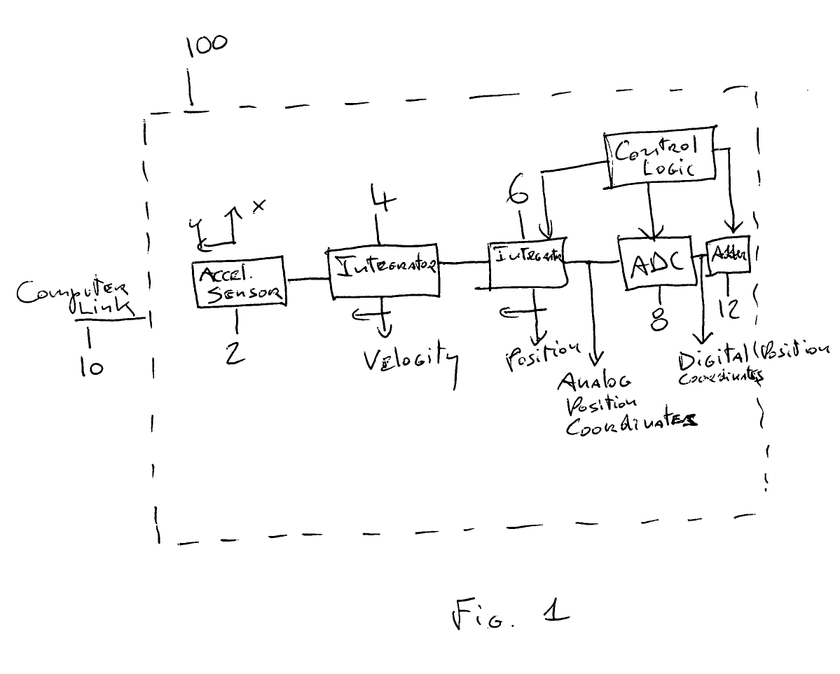

### DESCRIPTION OF FIG. 1—INERTIAL POINTER

A block diagram of an inertial pointer 100 is shown in FIG. 1. An acceleration sensor 2 measures acceleration of the mouse in the X, Y, or Z direction, respectively. The signal representing the acceleration in each direction can be integrated using an integrator circuit 4 to obtain the speed of motion of the pointer, and integrated again in an integrator circuit 6 to obtain the position of the pointer. The position coordinates can be transmitted directly to the computer using a wired or wireless link 10. The position coordinates can be transmitted to the computer as analog signals or converted to digital format using an analog-to-digital (ADC). Alternatively, either the acceleration or velocity information can be transmitted directly to the computer, and the processing of such quantities can be accomplished by means of circuitry or software located in the computer to determine the position coordinates for the inertial pointer in the electronic display.

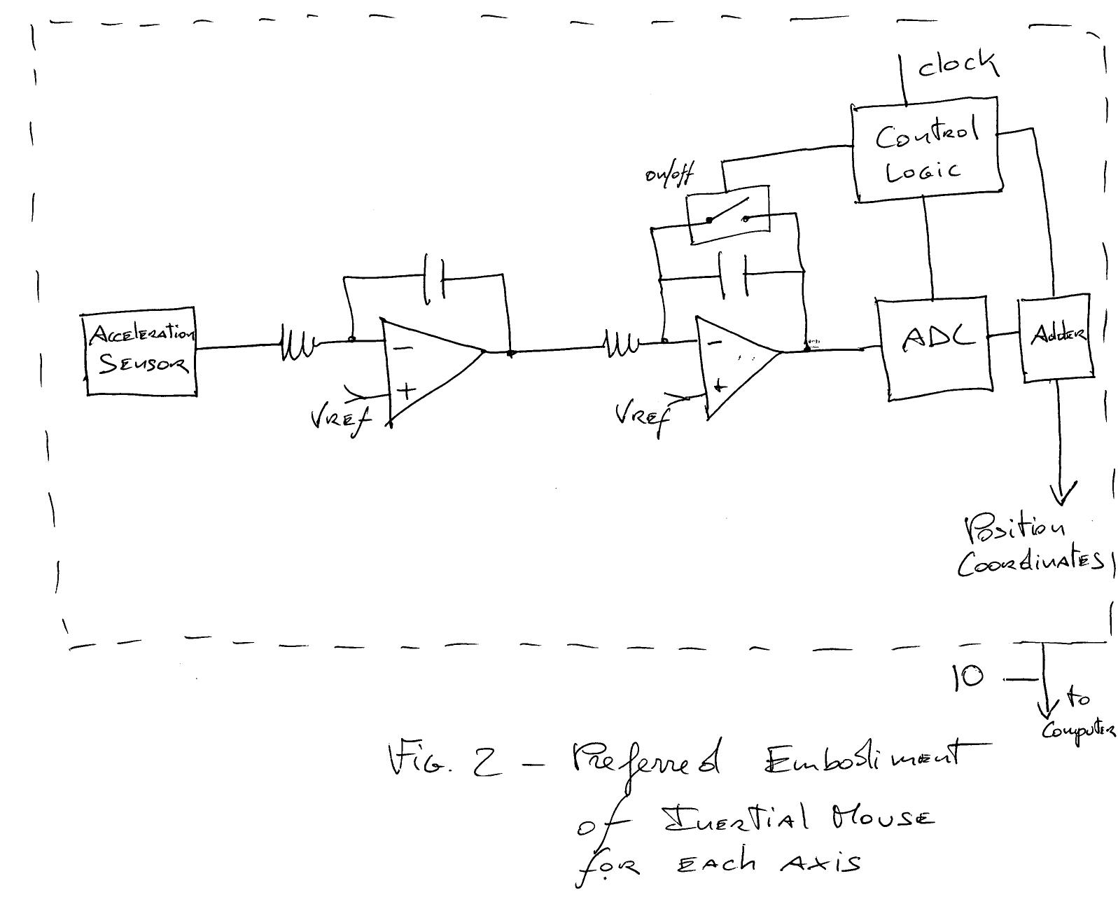

### DESCRIPTION OF FIG. 2—ACCELERATION-TO-POSITION CONVERSION CIRCUIT

A block diagram of a circuit to convert linear acceleration to position coordinates for each axis is shown in FIG. 2. An acceleration sensor 20 detects inertial motion (acceleration) and provides an acceleration signal 22. Acceleration signal 22 is integrated by integrator circuit 24 to generate a velocity signal 38. Velocity signal 38 is further integrated by integrator circuit 26, which includes a discharge switch 28 in parallel with an integrating capacitor 44. Control logic circuitry 32 uses a clock 40 to time the switching of discharge switch 28 at a frequency of typically 100 Hz, depending on the resolution and sensitivity desired for the pointer. Control logic circuitry 32 first enables a START control on ADC 30 to convert the output 42 of integrator 26 to a digital representation, and then enables discharge switch 32 so that capacitor 44 is discharged. The digital output 46 of ADC 30 is stored into a memory 34. The adder in memory 34 combines subsequent values of ADC output 46 to generate a digital representation of the position coordinate for a particular axis of the inertial mouse. The output of the adder can be transmitted to the computer using a wired or wireless link 10. Of course, the values of acceleration could be digitized by an ADC immediately from the acceleration sensor, and the integration could be performed in a digital signal processor.

An optional disable button 50 operated externally by the user can temporarily hold switch 28 enabled (shorted) to allow the mouse to be moved in space without a corresponding detection of motion. This option may be useful if the user wishes to move the mouse from one position to another, without moving the electronic pointer on the computer screen.

If the inertial pointer is used as a computer mouse, only X and Y coordinates on a horizontal plane are required. If the inertial pointer is used as a presentation tool or in a TV remote control, then only the X and Z coordinates on a vertical plane would be required. Of course, a more complex inertial pointer could be implemented with all three coordinates X, Y, and Z, where the third coordinate would provide three-dimensional effects. Lastly, if the inertial pointer is used in a mobile system such as a laptop, a reference accelerometer could be used in the mobile system in each reference direction to detect inertial motion of the entire system. Such information can then be used to correct the inertial information detected by the pointer and obtain only the relative motion of the pointer with respect to the laptop.

### CONCLUSION

The circuitry required to implement the inertial pointer is simple and cost-effective. Acceleration sensors are available today off-the-shelf at relatively low cost. Also, the advantages of a pointer based on sensing inertial motion are substantial A mouse pad is not required as in the traditional mechanical or optical mouse. Further, because a reference pad is not required, this invention is suitable for use in presentation tools and TV remote controls as well. Lastly, the accuracy of the inertial mouse can be very high, depending on the electrical characteristics of the acceleration sensor used. Therefore, the inertial pointer can provide the quality of a sophisticated optical mouse and the features of complex traditional pointing devices at virtually the price of a mechanical mouse.

The above description of the system illustrates numerous advantages of the inertial pointer for electronic displays disclosed. Those skilled in the art will appreciate that various adaptations and modifications of the just-described preferred embodiments can be configured without departing from the scope and spirit of the invention. Therefore, it is to be understood that within the scope of the appended claims, the invention may be practiced other than as specifically described herein.

1. An apparatus to determine position coordinates from sensing linear acceleration relative to space (inertia), comprising:
a linear acceleration sensor; and
an integrator,
wherein the acceleration is integrated at a rate appropriate for the resolution of the position coordinate.

2. The apparatus of claim 1 further including an analog-to-digital converter.

3. The apparatus of claim 2 further including a digital adder.

4. The apparatus of claim 1 further including a disable button operated externally by the user to allow said pointer to be moved in space without a corresponding detection of motion.

5. A method to determine position coordinates from sensing linear acceleration relative to space (inertia), comprising:
detecting acceleration; and
integrating said acceleration into position,
wherein said acceleration is integrated at a rate appropriate for the resolution of the position coordinate.
